(19) United States
(12) Patent Application Publication
(10) Pub. No.: US 2024/0018665 A1
(43) Pub. Date: Jan. 18, 2024

(54) HIGH EFFICIENCY ELECTROLYSIS DEVICE

(71) Applicant: KING MEMBRANE ENERGY TECHNOLOGY INC., TAINAN CITY (TW)

(72) Inventor: FUNG-CHING LIN, TAINAN CITY (TW)

(21) Appl. No.: 17/812,056

(22) Filed: Jul. 12, 2022

(51) Int. Cl. C25B 1/04; C25B 13/02; C25B 9/015; C25B 9/19; C25B 9/65

(52) U.S. Cl. CPC C25B 1/04; C25B 13/02; C25B 9/015; C25B 9/19; C25B 9/65

(57) ABSTRACT

A high efficiency electrolysis device is revealed. The electrolysis device includes a tubular membrane and an electrically conductive wire. The tubular membrane consists of an outer electrically conductive layer with an inner insulation layer disposed on an inner surface thereof, an insertion hole surrounded by the inner insulation layer, and a plurality of nano-scale filter holes penetrating the outer electrically conductive layer and the inner insulation layer. The electrically conductive wire is inserted through the insertion hole of the tubular membrane. Thereby the electrically conductive wire is located close to the outer electrically conductive layer to form a stronger electric field. A distance between the electrically conductive wire and the outer electrically conductive layer is fixed so that efficiency of water electrolysis will not be affected due to enlargement of the device. The electrolysis efficiency is improved due to larger surface area in contact with water per unit volume.

### BACKGROUND OF THE INVENTION

### Field of the Invention

The present invention relates to a high efficiency electrolysis device which not only forms a stronger electric field, but also gets easier to be enlarged for improving efficiency of water electrolysis. The efficiency of water electrolysis is not affected due to enlargement of the whole electrolysis device. The efficiency of water electrolysis is further improved due to larger surface area in contact with water per unit volume. The electrolysis device is more practical and effective.

### Description of Related Art

Fuel cells which uses hydrogen as energy sources have been considered as having a great potential to produce fixed amount of energy and use in transportation tools. The fuel cell is not only more efficient than internal combustion engines and other traditional energy devices, but also much cleaner due to less pollutants produced.

A fuel cell is a device that converts the chemical energy into electricity directly. Fuel cells can produce electricity continuously for as long as fuel and oxygen are supplied without being charged. Electrons generated in the fuel cell after electrochemical reaction flow from one electrode to the other electrode through an external circuit to react with an oxidizing agent. The oxidizing agent reacts after receiving the electrons and irons created move through the electrolyte in the cell. Thus a loop is formed in the operating fuel cell. The fuel cell has advantages of higher energy conversion efficiency, a more stable voltage, and sustainable power supply.

As to an electrolytic hydrogen generator revealed in Pat. Pub. No. M390321U which is published on Oct. 11, 2010, the electrolytic hydrogen generator for fuel cells includes an electrolytic cell, an anodic electrolysis member, two cathodic electrolysis members, and a pressurizing device. The electrolytic cell is an air-tight container provided having an inner space divided into one anodic electrolysis cell and two cathodic electrolysis cells, each of which is arranged adjacent to each other. A baffle is disposed between the anodic electrolysis cell and the cathodic electrolysis cell while both the anodic electrolysis cell and the cathodic electrolysis cell are provided with an air valve on a top thereof. The anodic electrolysis member which is made of highly oxidative metal is mounted in the anodic electrolysis cell and connected to a positively charged electrode of a DC (direct current) power source. The respective cathodic electrolysis members are disposed in the cathodic electrolysis cells correspondingly and connected to a negatively charged electrode of the DC power source. The pressurizing device is connected to the electrolysis cell and communicating with the inner space of the electrolysis cell for pressuring the electrolysis cell during electrolysis.

Although the above improved hydrolysis device used for production of hydrogen can generate hydrogen by hydrolysis as expected, the hydrogen generating efficiency is not good and the hydrogen gas is generated slowly. Thereby the use cost is unable to be reduced effectively.

Thus there is room for improvement and there is a need to provide a high efficiency electrolysis device which is more practical and effective.

### SUMMARY OF THE INVENTION

Therefore, it is a primary object of the present invention to provide a high efficiency electrolysis device which is formed by an electrically conductive wire inserted through an insertion hole of at least one tubular membrane and located quite close to an outer electrically conductive layer of the tubular membrane to form a stronger electric field. A distance between the electrically conductive wire and the outer electrically conductive layer is fixed so that efficiency of water electrolysis will not be affected due to enlargement of the whole electrolysis device. Thereby the electrolysis device can be enlarged easier for improvement of the efficiency of water electrolysis. Moreover, there is larger surface area in contact with water per unit volume of the device. Thereby the efficiency of water electrolysis is further increased.

In order to achieve the above objects, a high efficiency electrolysis device according to the present invention includes a tubular membrane and an electrically conductive wire.

The tubular membrane is provided with an outer electrically conductive layer and an inner insulation layer disposed on an inner surface of the outer electrically conductive layer. An insertion hole is surrounded by the inner insulation layer and a plurality of nano-scale filter holes is penetrating both the outer electrically conductive layer and the inner insulation layer. The outer electrically conductive layer is connected to one electrode of a direct current (DC) power source.

The electrically conductive wire is inserted through the insertion hole of the tubular membrane and connected to the other electrode of the DC power source.

Preferably, the tubular membrane is flexible.

Preferably, a plurality of the tubular membranes forms a tubular membrane set which is then mounted in an electrolysis cell. The electrically conductive wire is inserted through the insertion holes of the respective tubular membranes. The outer electrically conductive layer of the tubular membrane is connected to one electrode of a direct current (DC) power source while the electrically conductive wire is connected to the other electrode of the DC power source. Then water flows through the respective insertion holes of the tubular membranes of the tubular membrane set and comes out from the plurality of nano-scale filter holes penetrating the outer conductive layer and the inner insulation layer of the respective tubular membranes. Thereby electrolysis of water flow is carried out by flow of electricity conducted through the outer electrically conductive layer and the electrically conductive wire. Hydrogen gas is generated at one end of either the outer electrically conductive layer or the electrically conductive wire connected to a cathode (negatively charged electrode) of the DC power source. Then the hydrogen gas produced is collected and stored in a hydrogen collection container for later use.

Preferably, oxygen gas is generated at one end of either the outer electrically conductive layer or the electrically conductive wire connected to an anode (positively charged electrode) of the DC power source. Then the oxygen gas generated is collected and stored in an oxygen collection container for later use.

Preferably, the outer electrically conductive layer is made of a mixture of polymers and electrically conductive materials.

Preferably, the polymer of the outer electrically conductive layer can be polyvinylidene difluoride (PVDF), polysulfone (PSF), cellulose acetate (CA), poly (methyl methacrylate) (PMMA), polyethersulfone (PESF), or nylon.

Preferably, the electrically conductive material of the outer electrically conductive layer can be graphene, carbon, graphite, metal powder, or metal oxide powder.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a schematic drawing showing an embodiment in use according to the present invention.

### DETAILED DESCRIPTION OF THE PREFERRED EMBODIMENT

In order to learn technical features and functions of the present invention more completely and clearly, please refer to the following embodiments, related figures and reference signs.

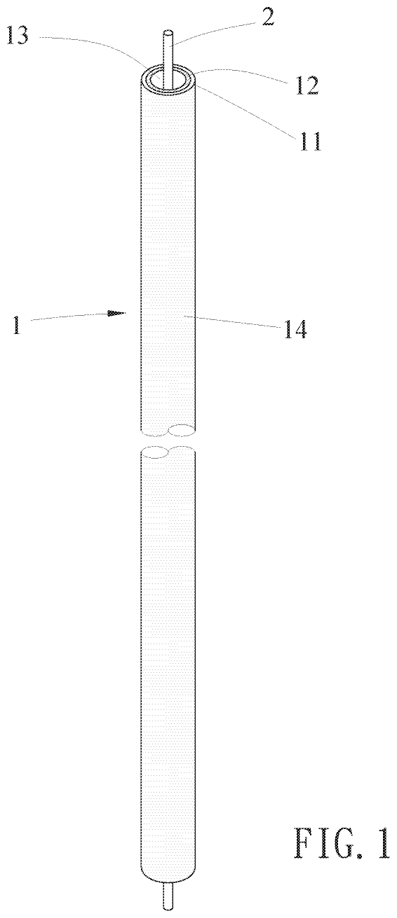

Refer to FIG. 1, a high efficiency electrolysis device according to the present invention includes a tubular membrane 1 and an electrically conductive wire 2.

The tubular membrane 1 is flexible and composed of an outer electrically conductive layer 11, an inner insulation layer 12 disposed on an inner surface of the outer electrically conductive layer 11, an insertion hole 13 surrounded by the inner insulation layer 12, and a plurality of nano-scale filter holes 14 penetrating both the outer electrically conductive layer 11 and the inner insulation layer 12. The outer electrically conductive layer 11 is made of a mixture of polymers with electrically conductive materials. The polymer can be polyvinylidene difluoride (PVDF), polysulfone (PSF), cellulose acetate (CA), poly (methyl methacrylate) (PMMA), polyethersulfone (PESF), or nylon. The electrically conductive material can be graphene, carbon, graphite, metal powder, metal oxide powder, and so on. A thickness of the outer electrically conductive layer 11 is between 0.05 mm and 0.5 mm. The inner insulation layer 12 is made of polyester yarn or insulation yarn with a thickness of 0.1 mm-0.5 mm A diameter of the insertion hole 13 and the nano-scale filter hole 14 is 0.8 mm-1.2 mm and 0.051 am-51 am respectively.

The electrically conductive wire 2 which is made of metal or nonmetal electrically conductive materials and having a diameter ranging from 0.2 mm to 0.8 mm is inserted through the insertion hole 13 of the tubular membrane 1.

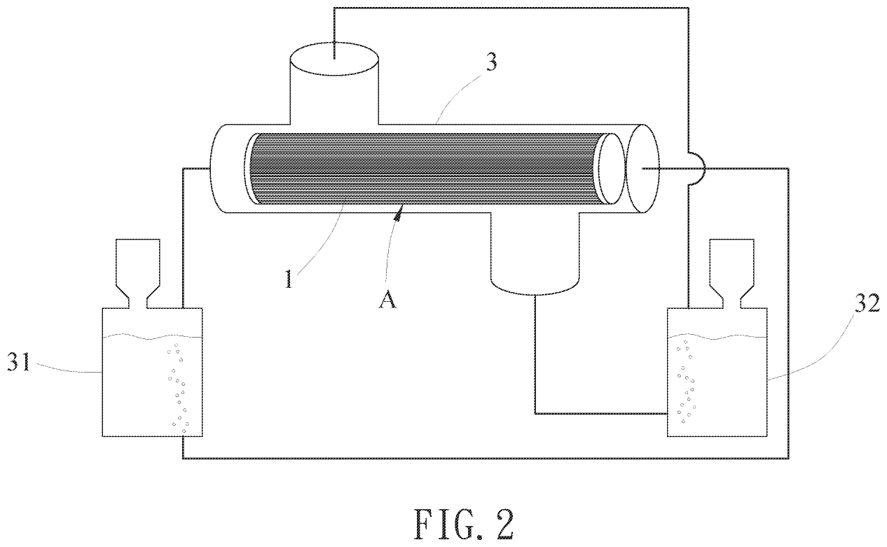

Refer to FIG. 2, while in use, a plurality of the tubular membranes 1 forms a tubular membrane set A which is then mounted in an electrolysis cell 3. The electrically conductive wire 2 is inserted through the insertion holes 13 of the respective tubular membranes 1. The outer electrically conductive layer 11 of the tubular membrane 1 is connected to one electrode of a direct current (DC) power source while the electrically conductive wire 2 is connected to the other electrode of the DC power source. Then water flows through the respective insertion holes 13 of the tubular membranes 1 of the tubular membrane set A and comes out from the plurality of nano-scale filter holes 14 penetrating the outer electrically conductive layer 11 and the inner insulation layer 12 of the respective tubular membranes 1. Thereby electrolysis of water flow is carried out by flow of electricity conducted through the outer electrically conductive layer 11 of the tubular membrane 1 and the electrically conductive wire 2 inserted through the insertion holes 13. The water flow is circulating and the electrolysis is performed repetitively so that a higher electrolysis efficiency is achieved. Hydrogen gas is generated at one end of either the outer electrically conductive layer 11 or the electrically conductive wire 2 connected to a cathode (negatively charged electrode) of the DC power source and then the hydrogen gas produced is collected and stored in a hydrogen collection container 31 for later use. During electrolysis of water flow carried out by the flow of electricity conducted through the outer electrically conductive layer 11 of the tubular membrane 1 and the electrically conductive wire 2 in the insertion hole 13, oxygen gas is produced at one end of either the outer electrically conductive layer 11 or the electrically conductive wire 2 connected to an anode (positively charged electrode) of the DC power source and then the oxygen gas generated is collected and stored in an oxygen collection container 32 for later use.

In summary, the present device has the following advantages compared with the techniques available now.
1. The electrically conductive wire is inserted through the insertion hole of the tubular membrane and the electrically conductive wire is located quite close to the outer electrically conductive layer so that the electric field formed is stronger and efficiency of water electrolysis is further increased.
2. The electrically conductive wire is inserted through the insertion hole of the tubular membrane and the distance between the electrically conductive wire and the outer electrically conductive layer is fixed. Thus the efficiency of water electrolysis will not be affected due to enlargement of the whole device. Moreover, the whole device is easier to be enlarged due to the compact volume occupied for increasing the efficiency of water electrolysis.
3. The electrically conductive wire is inserted through the insertion hole of the tubular membrane so that there is larger surface area in contact with water per unit volume of the device and the efficiency of water electrolysis is further improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A high efficiency electrolysis device comprising a tubular membrane and an electrically conductive wire;
wherein the tubular membrane is provided with an outer electrically conductive layer connected to one electrode of a direct current (DC) power source, an inner insulation layer disposed on an inner surface of the outer electrically conductive layer, an insertion hole surrounded by the inner insulation layer, and a plurality of nano-scale filter holes penetrating the outer electrically conductive layer and the inner insulation layer;
wherein the electrically conductive wire is inserted through the insertion hole of the tubular membrane and connected to the other electrode of the DC power source.

2. The high efficiency electrolysis device as claimed in claim 1, wherein the tubular membrane is flexible.

3. The high efficiency electrolysis device as claimed in claim 1, wherein a plurality of the tubular membranes forms a tubular membrane set which is then mounted in an electrolysis cell; the electrically conductive wire is inserted through the insertion holes of the respective tubular membranes; the outer electrically conductive layer of the tubular membrane is connected to one electrode of a direct current (DC) power source while the electrically conductive wire is connected to the other electrode of the DC power source; wherein water flows through the insertion holes of the tubular membranes of the tubular membrane set and comes out from the plurality of nano-scale filter holes penetrating the outer conductive layer and the inner insulation layer of the tubular membranes; thereby electrolysis of the water is carried out by flow of electricity conducted through the outer electrically conductive layer and the electrically conductive wire; wherein hydrogen gas is generated at one end of either the outer electrically conductive layer or the electrically conductive wire connected to a cathode (negatively charged electrode) of the DC power source and then the hydrogen gas generated is collected and stored in a hydrogen collection container for later use.

4. The high efficiency electrolysis device as claimed in claim 1, wherein oxygen gas is generated at one end of either the outer electrically conductive layer or the electrically conductive wire connected to an anode (positively charged electrode) of the DC power source and then the oxygen gas generated is collected and stored in an oxygen collection container for later use.

5. The high efficiency electrolysis device as claimed in claim 1, wherein the outer electrically conductive layer is made of a mixture of polymers and electrically conductive materials.

6. The high efficiency electrolysis device as claimed in claim 5, wherein the polymer of the outer electrically conductive layer is selected from the group consisting of polyvinylidene difluoride (PVDF), polysulfone (PSF), cellulose acetate (CA), poly (methyl methacrylate) (PMMA), polyethersulfone (PESF), and nylon.

7. The high efficiency electrolysis device as claimed in claim 5, wherein the electrically conductive material of the outer electrically conductive layer is selected from the group consisting of graphene, carbon, graphite, metal powder, and metal oxide powder.
